(19) United States
(12) Patent Application Publication
(10) Pub. No.: US 2005/0150921 A1
(43) Pub. Date: Jul. 14, 2005

(54) Saddlebag mounting system

(76) Inventor: Daniel H. Schneider, Franklin, WI (US)

Correspondence Address: MICHAEL BEST & FRIEDRICH, LLP, 100 E WISCONSIN AVENUE, MILWAUKEE, WI, 53202, US

(21) Appl. No.: 10/754,391

(22) Filed: Jan. 9, 2004

(51) Int. Cl. B62J 7/00; B62J 9/00; B62J 11/00

(52) U.S. Cl. 224/413

(57) ABSTRACT

A saddlebag mounting system for use with a motorcycle. The saddlebag mounting system comprising a saddlebag and a saddlebag frame fixedly attached to the saddlebag. The saddle bag frame includes a hook member that extends a distance from the saddlebag. The hook member is adapted to couple to a portion of the motorcycle to at least partially support the saddlebag

### BACKGROUND

The present invention generally relates to motorcycles, and particularly to motorcycles that include a removable saddlebag.

Motorcycles are commonly used as a means of transportation, much like an automobile. However, unlike an automobile, motorcycles do not generally include provisions for storage of even relatively small quantities of items (e.g., change of clothing). As such, many motorcycles include saddlebags mounted to the motorcycle near the rear to provide for the desired storage.

In some cases, a rider may wish to remove the saddlebags and, as such, it is desirable to include a mounting system that allows for the quick removal and reinstallation of the saddlebags without the use of tools.

### SUMMARY

The present invention provides a saddlebag mounting system for a motorcycle that includes a fender support. The mounting system includes a saddlebag mount that is attached to the fender support. The saddlebag mounting system includes a saddlebag frame that attaches to a saddlebag and engages the saddlebag mount to attach the saddlebag to the motorcycle. In one construction, the saddlebag frame includes a hook member that engages the saddlebag mount. In another construction, the saddlebag mount attaches to the fender support at two or more mounting points that are spaced apart from one another. In yet another construction, the saddlebag mount includes a bar that mounts to and extends along the fender support.

### BRIEF DESCRIPTION OF THE DRAWINGS

The detailed description particularly refers to the accompanying figures in which:

FIG. 1 is a side view of a motorcycle embodying the present invention;

FIG. 2 is a perspective view of a rear portion of the motorcycle of FIG. 1;

FIG. 3 is a partially exploded view of the saddlebag mounting system of FIG. 2;

FIG. 4 is an enlarged perspective view of a portion of the saddlebag mounting system of FIG. 2;

FIG. 5 is an enlarged perspective view of the saddlebag of FIG. 2;

FIG. 6 is cross-section taken along line 6-6 in FIG. 4 with the system fully assembled; and

FIG. 7 is an enlarged perspective view of a portion of the saddlebag mounting system of FIG. 2 illustrating a removable backrest bracket.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of“having”, “including”, and “comprising” and variations thereof herein is meant to encompass the items listed thereafter and equivalents thereof as well as additional items. The use of letters to identify elements of a method or process is simply for identification and is not meant to indicate that the elements should be performed in a particular order.

### DETAILED DESCRIPTION OF THE DRAWINGS

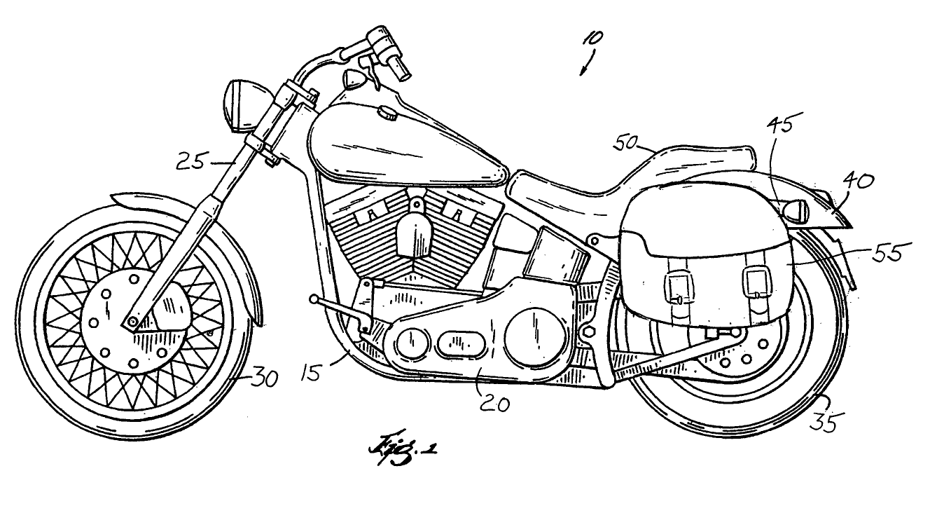

FIG. 1 illustrates a motorcycle 10 having a frame 15, and an engine and transmission assembly 20 mounted to the frame 15. A steering assembly 25 pivotally mounted to the frame 15, and a front wheel 30 rotatably mounted to the steering assembly 25 support the front of the motorcycle 10. A rear wheel 35 is rotatably interconnected with the frame 15 and supports the rear of the motorcycle 10. The rear wheel 35 is driven by operation of the engine and transmission assembly 20. A rear fender 40 is positioned between two fender supports 45 (only one shown in FIG. 1) that support the rear fender 40 above the rear wheel 35. The motorcycle 10 also includes a seat 50 upon which a motorcycle operator may sit while operating the motorcycle 10. A pair of saddlebags 55 are removably attached to the rear of the motorcycle 10, as will be described below in more detail.

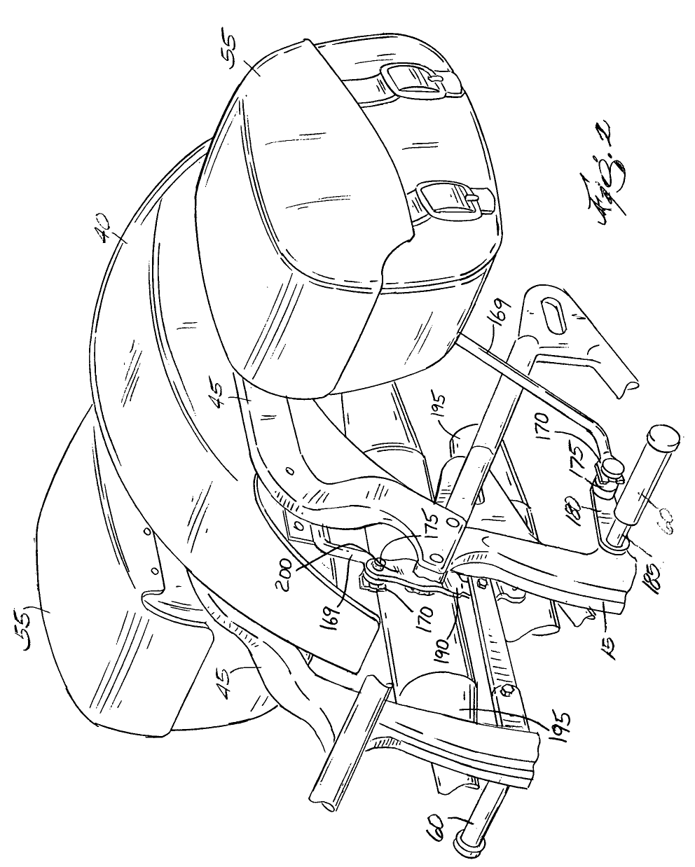

Referring to FIG. 2, the fender supports 45 attach to the frame 15 and extend towards the rear of the motorcycle 10 to provide mounting points for the rear fender 40. In some constructions, the fender supports 45 are positioned within the fender 40 and are not visible when the rear fender 40 is mounted. In other constructions, the fender supports 45 sandwich the rear fender 40 and, as such, are at least partially visible. In still other constructions, a combination of hidden and/or visible members makes up the fender supports 45 (e.g., a frame member and an aesthetically appealing cover). The rear fender 40 defines two substantially parallel surfaces that engage the fender supports 45 when the rear fender 40 is attached to the motorcycle 10. The frame 15 also supports a pair of rear foot pegs 60 that can support a passenger's feet when a passenger is present.

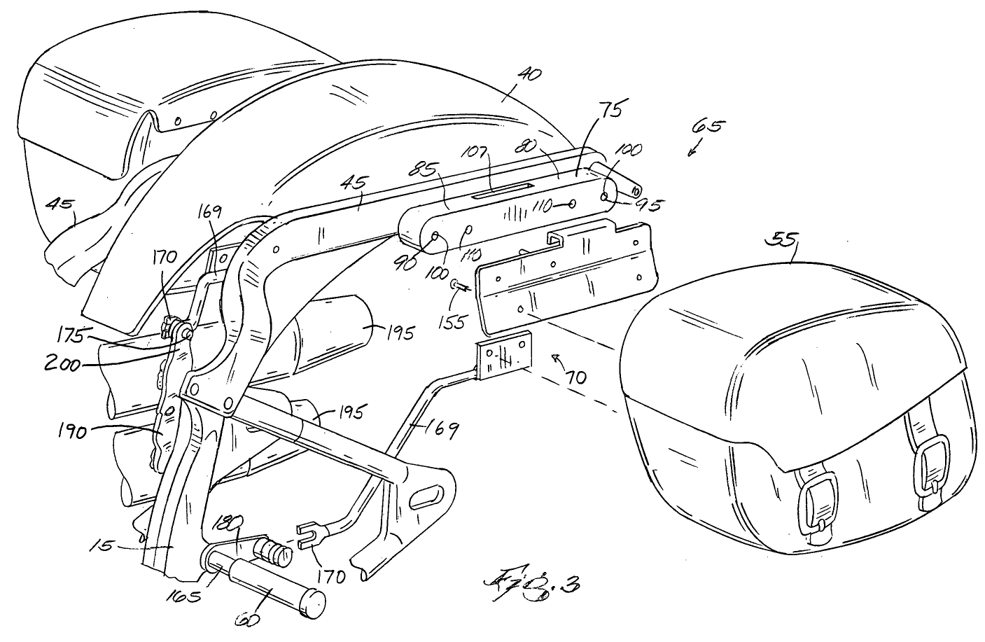

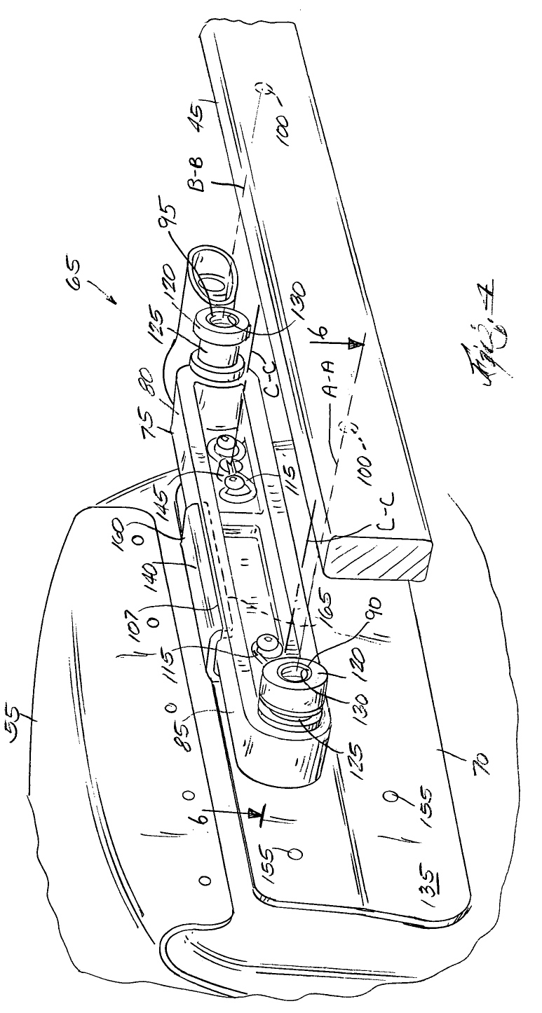

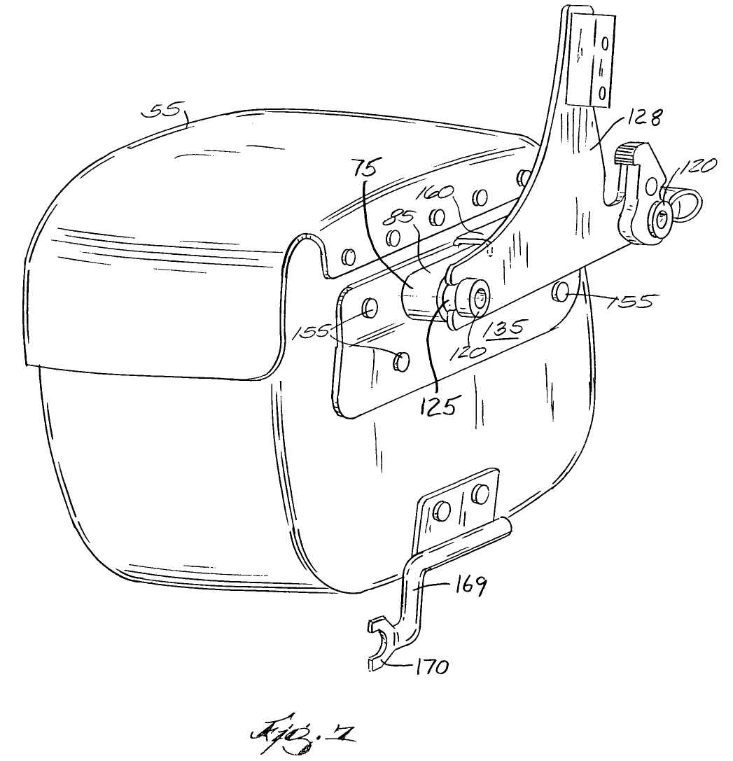

Turning to FIGS. 3 and 4, a saddlebag mounting system 65 is illustrated in a partially exploded state. The saddlebag mounting system 65 includes the saddlebag 55, a saddlebag frame 70, and a saddlebag mount 75. The saddlebag mount 75 connects to the fender support 45 and can remain connected to the fender support 45 whether or not the saddlebag 55 is attached to the motorcycle 10. The saddlebag mount 75 includes an elongated bar 80 that defines a top surface 85 and first and second apertures 90, 95. Of course other constructions may use more or less apertures or may space the apertures differently, while still functioning as desired. Each aperture 90, 95 receives a mounting member 105 (FIG. 6), which attaches the bar 80 to the fender support 45. In most constructions, the mounting members 105 are bolts that extend along a first mounting axis A-A and a second mounting axis B-B to engage the fender support 45. Other constructions may employ other fastening means (e.g., screws, rivets, pins, welding, soldering, brazing, and the like).

The top surface 85 of the bar 80 includes an elongated slot 107 that extends along a portion of the length of the bar. The slot 107 has a depth that is less than the height of the bar 80, thus defining a blind hole or slot. Other constructions may employ a through-slot if desired. While the illustrated slot 107, is centered along the length of the bar 80, other constructions may employ an off center slot 107 or multiple slots 107 disposed along the length of the bar 80.

With continued reference to FIG. 3 and FIG. 4, the bar 80 also includes two pin-receiving apertures 110, which define attachment axes C-C that are parallel to and not aligned with either of the mounting axes A-A, B-B. In the illustrated embodiment, the pin-receiving apertures 110 are positioned between the first and second apertures 90, 95. However, other constructions may locate one or both of the pin-receiving apertures 110 outside of the mounting points 90, 95. A retaining member (shown in FIG. 4), in the form of an S-shaped spring 115 is positioned adjacent each of the pin-receiving apertures 110 to facilitate attachment of the saddlebag 55 to the saddlebag mount 75.

In the illustrated construction, spacer pieces 120 are positioned between the fender 40 or fender support 45 and the bar 80. The spacers 120 include one or more accessory support surfaces 125. Generally, the support surfaces 125 are cylindrical and sized to receive a particular accessory. For example, in the construction illustrated in FIG. 7, a removable bracket 128 for a backrest or luggage rack can engage the support surface 125 of the spacer pieces 120 and be at least partially supported by the spacers 120. As one of ordinary skill will realize, many different accessories can be supported in this manner. In addition, the spacers 120 can support more than one accessory. As such, the invention should not be limited to the type or quantity of accessory described herein.

The spacers 120 each include a central aperture 130 sized to allow the passage of the mounting member 105. In another construction, one or more of the spacers 120 are formed as part of the bar 80 or are fixedly attached (e.g., welded) to the bar 80.

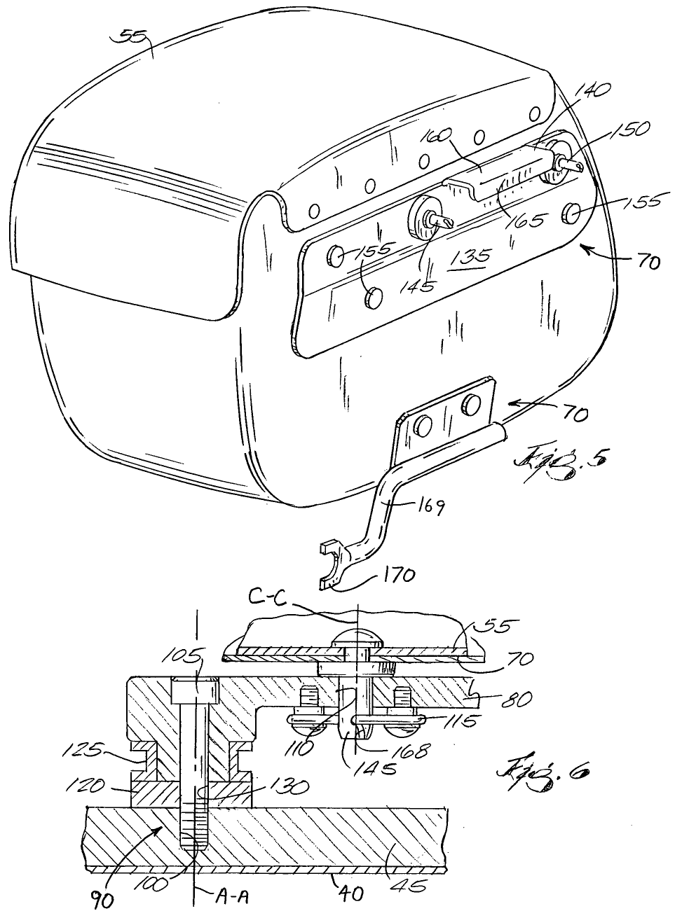

As illustrated in FIG. 5, the saddlebag frame 70 includes a plate member 135, a hook 140, a first attachment pin 145, and a second attachment pin 150. Several rivets 155 pass through the plate 135 and fixedly attach the plate 135 to a rigid back panel of the saddlebag 55. In other constructions, other attachment means are used (e.g., bolts, screws, adhesive, welding, stitching, and the like). The hook 140 is integrally formed as part of the plate 135 and includes a first surface 160 that is substantially perpendicular to the plate 135 and a second surface 165 that is substantially parallel to the plate 135. The second surface 165 is sized and positioned to at least partially engage the slot 107 when the saddlebag 55 is attached to the motorcycle 10. As such, the hook 140 is configured to match the location of the slot 107. Other constructions may not include a slot 107. Rather, the hook 140 could extend beyond the bar 80 and engages the opposite side of the bar 80. In other constructions, two or more hook members are spaced apart from one another and cooperate to define the hook 140 that engage one or more slots 107.

The first attachment pin 145 and the second attachment pin 150 pass through the saddlebag 55 and through apertures in the plate 135 such that the pins 145, 150 extend beyond the surface of the plate 135. The pins 145, 150 remain rotatable within the apertures when installed as shown in FIG. 5.

With reference to FIG. 6, an attachment pin 145 is shown illustrating a pin cam surface 168. The pin cam surface 168 engages the S-shaped spring 115 and, when rotated, couples the saddlebag 55 to the motorcycle 10. The cam surface 168 receives and engages the S-shaped spring 115 during rotation of the pin 145, 150 and pulls the spring 115 towards the saddlebag 55. This produces a force that helps to maintain the pin 145 in the locked position during use of the motorcycle 10. Attachment pin 150 also includes the pin cam surface 168. Some constructions may include a pin locking mechanism that retains or biases the pin into the locked position.

The saddlebag frame 70 further includes a support arm 169 having a yoke 170. As illustrated in FIGS. 2 and 3, the yoke 170, disposed at one end of the support arm 169, engages the motorcycle 10. The opposite end of the support arm 169 engages the saddlebag 55. In the illustrated construction, the left side yoke 170 engages a yoke pin 175 supported by a yoke bracket 180 that extends from a foot peg support 185. The foot peg support 185 supports the rear foot peg 60. The right side yoke 170 engages a yoke pine 170 that is supported by an exhaust pipe bracket 190. The exhaust pipe bracket 190 at least partially supports a pair of exhaust pipes 195 and includes an extension 200 that supports a yoke pin 175.

As one of ordinary skill will realize, many different points can be used to support the yoke 170. For example, the yoke 170 can engage a support that is formed as part of the foot peg 60 or the foot peg support 185, rather than a separate pin as illustrated in FIGS. 2 and 3. In addition, the same mounting points can be used on the right side and the left side of the motorcycle if desired.

To attach the saddlebag 55 to the motorcycle 10, the yoke 170 is engaged with the yoke pin 175 and the hook 140 is positioned to engage the slot 107 disposed within the top surface 85 of the bar 80. The pins 145, 150 pass through the pin-receiving apertures 110 in the bar 80 and are rotated to engage the S-shaped springs 115. As the pins 145, 150 rotate, the plate 135 is pulled toward the bar 80. In this manner the saddlebag 55 is fixedly attached to the motorcycle 10 and the yoke 170, the hook 140, the first attachment pin 145, and the second attachment pin 150 support its weight. To remove the saddlebag 55, the pins 145, 150 are rotated to release the S-shaped springs 115 and the saddlebag 55 is lifted off of the motorcycle 10. The hook 140 disengages the slot 107 and the yoke 170 disengages the yoke pin 175 as the saddlebag 55 is lifted. The bar 80 can remain attached to the fender 40 when the saddlebag 55 is attached to the motorcycle 10 and when the saddlebag 55 is not attached to the motorcycle 10.

Although the invention has been described in detail with reference to certain preferred embodiments, variations and modifications exist within the scope and spirit of the invention as described and defined in the following claims.

1. A saddlebag mounting system for use with a motorcycle, the saddlebag mounting system comprising:
a saddlebag; and
a saddlebag frame fixedly attached to the saddlebag and including a hook member extending a distance from the saddlebag, the hook member adapted to couple to a portion of the motorcycle to at least partially support the saddlebag.

2. The saddlebag mounting system of claim 1, further comprising a saddlebag mount fixedly attached to the fender support, the hook adapted to engage the saddlebag mount.

3. The saddlebag mounting system of claim 2, wherein the saddlebag mount includes a bar attached to the fender support at a first mounting point and a second mounting point spaced a distance from the first mounting point.

4. The saddlebag mounting system of claim 3, wherein the bar includes a first attachment member disposed between the first mounting point and the second mounting point and a second attachment member disposed between the first mounting point and the second mounting point, the first and second attachment members adapted to couple to the saddlebag.

5. The saddlebag mounting system of claim 4, further comprising a first pin engageable with the saddlebag and the first attachment member and a second pin engageable with the saddlebag and the second attachment member.

6. The saddlebag mounting system of claim 5, wherein each of the first pin and the second pin includes a cam surface that engages the first attachment member and the second attachment member, respectively.

7. The saddlebag mounting system of claim 1, wherein the saddlebag frame includes a yoke member engageable with the motorcycle to at least partially support the saddlebag.

8. The saddlebag mounting system of claim 1, wherein the hook member is integrally formed as part of the saddlebag frame.

9. A saddlebag mounting system for use with a motorcycle having a fender support, the saddlebag mounting system comprising:
a saddlebag;
a saddlebag mount including at least one mounting axis, the saddlebag mount fixedly attached to the fender support along the first mounting axis and the second mounting axis; and
a saddlebag frame fixedly attached to the saddlebag, the saddlebag frame engageable with the saddlebag mount along an attachment axis, the attachment axis not being aligned with any of the mounting axes.

10. The saddlebag mounting system of claim 9, wherein the saddlebag frame includes a hook member extending a distance from the saddlebag, the hook member adapted to engage the saddlebag mount to at least partially support the saddlebag.

11. The saddlebag mounting system of claim 10, wherein the hook member is integrally formed as part of the saddlebag frame.

12. The saddlebag mounting system of claim 9, wherein the saddlebag mount includes a bar attached to and extending along the fender support.

13. The saddlebag mounting system of claim 12, wherein the bar includes a first attachment member disposed between the first attachment axis and the second attachment axis and a second attachment member disposed between the first attachment axis and the second attachment axis, the first and second attachment members adapted to couple to the saddlebag.

14. The saddlebag mounting system of claim 13., further comprising a first pin engageable with the saddlebag and the saddlebag mount and a second pin engageable with the saddlebag and the saddlebag mount.

15. The saddlebag mounting system of claim 14, wherein each of the first pin and the second pin includes a cam surface that engages the first attachment member and the second attachment member respectively.

16. The saddlebag mounting system of claim 9, wherein the saddlebag frame includes a yoke member engageable with the motorcycle to at least partially support the saddlebag.

17. The saddlebag mounting system of claim 9, wherein the first mounting axis is spaced a parallel distance from a second mounting axis, the first attachment axis is parallel to and positioned between the first mounting axis and the second mounting axis and the second attachment axis is parallel to the first attachment axis and positioned between the first mounting axis and the second mounting axis.

18. A saddlebag mounting system for use with a motorcycle having a length, the saddlebag mounting system comprising:
a saddlebag;
a saddlebag mount attached to the motorcycle, the saddlebag mount including a bar that extends along a portion of the length of the motorcycle; and
a saddlebag frame fixedly attached to the saddlebag and engaged with the bar such that the bar at least partially supports the saddlebag.

19. The saddlebag mounting system of claim 18, wherein the saddlebag frame includes a hook member extending a distance from the saddlebag, the hook member adapted to engage the saddlebag mount to at least partially support the saddlebag.

20. The saddlebag mounting system of claim 19, wherein the hook member is integrally formed as part of the saddlebag frame.

21. The saddlebag mounting system of claim 18, wherein the bar includes a first attachment member disposed between the first mounting point and the second mounting point and a second attachment member disposed between the first mounting point and the second mounting point.

22. The saddlebag mounting system of claim 21, further comprising a first pin engageable with the saddlebag and the first attachment member and a second pin engageable with the saddlebag and the second attachment member.

23. The saddlebag mounting system of claim 22, wherein each of the first pin and the second pin includes a cam surface that engages the first attachment member and the second attachment member, respectively.

24. The saddlebag mounting system of claim 18, wherein the saddlebag frame includes a yoke member engageable with the motorcycle to at least partially support the saddlebag.

25. The saddlebag mounting system of claim 18, wherein the saddlebag mount includes a pair of spacers adapted to at least partially support an accessory, the accessory supported such that the bar covers at least a portion of the accessory.

26. A saddlebag assembly attachable to a motorcycle, the saddlebag assembly comprising:
a saddlebag;
a hook coupled to and extending from the saddlebag, the hook adapted to engage the motorcycle such that the hook at least partially supports the saddlebag.

27. The saddlebag assembly of claim 26, wherein the hook is integrally formed as part of the saddlebag frame.

28. The saddlebag assembly of claim 26, wherein the saddlebag frame includes a yoke member engageable with the motorcycle to at least partially support the saddlebag.

29. The saddlebag assembly of claim 28, wherein the hook and the yoke are integrally formed as part of the saddlebag frame.

30. The saddlebag assembly of claim 26, further comprising a first pin engageable with the saddlebag and the motorcycle and a second pin engageable with the saddlebag and the motorcycle.

31. The saddlebag assembly of claim 30, wherein each of the first pin and the second pin includes a cam surface that engages the motorcycle.
